(19) United States
(12) Patent Application Publication
(10) Pub. No.: US 2005/0194329 A1
(43) Pub. Date: Sep. 8, 2005

(54) Napkin and condiment-holder with turnable roasting fork

(76) Inventor: Lewis G. Bolling, Boise, ID (US)

Correspondence Address: Donald W. Meeker;Patent Agent, 924 East Ocean Front #E, Newport Beach, CA, 92661, US

(21) Appl. No.: 10/792,052

(22) Filed: Mar. 3, 2004

(51) Int. Cl. B42F 1/00

(52) U.S. Cl. 211/50

(57) ABSTRACT

A napkin holder has a heat shield and a condiment holder and top rings to support a turnable long handled fork for roasting food over an adjacent heat source. The fork handle extends for turning. The fork end is separable from the handle for cleaning and separate storage leaving the handle for lifting the napkin holder.

### BACKGROUND OF THE INVENTION

1. Field of the Invention

The present invention relates to napkin holders and particularly to a napkin holder that also holds condiments and supports and holds a pivotable fork for hot dog roasting, said napkin holder further comprises a heat shield for protecting the paper napkins.

2. Description of the Prior Art

Camping and many similar outdoor activities inevitably involve the task of cooking over an open fire or on a camp stove. Traditionally, campers support a hot dog, sausage, or the like over the campfire during cooking with a fork or a sharpened stick. The sharp end of the stick or fork is normally pushed through one or more hot dogs, and is then hand-held with the hot dogs positioned immediately over the fire so that the heat of the fire cooks the hot dogs.

Home hot dog roasting over a stove top using a simple device which also holds napkins and condiments is not considered by the prior art.

U.S. Pat. No. 1,061,431, issued May 13, 1913 to West, claims a stand for supporting toasting forks in front of a fire, which comprises a rectangular base, a rectangular containing member to fit in the base, two double legged standard members hinged to said base, means for holding the standard members in a vertical position, upwardly projecting hooks one standard, and inverted hooks on the other standard, such hooks being adapted to carry and counterbalance respectively the toasting fork(s) in the required position.

U.S. Pat. No. 2,522,223, issued Sep. 12, 1950 to Hardin, discloses a barbecue and campfire cooking apparatus support, which comprises a standard, a slide embracing and slidable longitudinally on said standard and a cooking implement having a handle shank, such as a barbecue fork. The slide has oppositely extending arms and is adapted to, when tilted, engage the standard automatically and support a load. The arms have opposite downwardly and upwardly directed loops on their outer end portions, which movably engage the median portion of the handle shank, thereby supporting the cooking implement. The shank may have multiple key means adapted to engage the loops, whereby the cooking utensil may be locked in any one of a plurality of reversible positions.

U.S. Pat. No. 2,517,448, issued Aug. 1, 1950 to Schmeling, describes a picnic fork with a shank that has a handle portion at one end and prongs at the other, which is characterized by the provision of a supporting stake joined at one end to the shank by a connection affording pivotal motion and unrestricted rotation of the shank. When not in use the stake may be swung about its connection with the shank to a position directly alongside and parallel to the shank. The free end of the stake may be held in place by a socket in the handle.

U.S. Pat. No. 6,234,162, issued May 22, 2001 to Wenker, puts forth an apparatus for cooking food items over an open fire, which allows a cook to turn the food and adjust the position of the food over the fire while maintaining a safe distance from the fire. The apparatus is constructed and arranged to allow hands-free operation or, if desired, allow a cook to continually control the position of the food over the fire using one hand. This is accomplished using a telescopic handle and two supports.

U.S. Pat. No. 4,320,700, issued Mar. 23, 1982 to Stachowicz, provides an apparatus for suspending one or more long-shafted forks in a vertical position for storage and in a horizontal operative position whereby the forks may be used to hold food over an open heat source. The apparatus comprises a base having dimensions sufficient to provide vertical stability, a stand post mounted vertically to the base, an upper bracket adapted to hold the forks vertically at the handles, and a lower bracket having a cradle and hook retaining means for retaining the forks horizontally in the second operative position. The lower bracket is also vertically movable along the stand post, and the hook and cradle retaining means are pivotable about a cross bracket portion of the lower bracket whereby the forks may be adjusted horizontally over the heat source.

U.S. Pat. No. 4,539,751, issued Sep. 10, 1985 to Chan, indicates a barbeque fork which can be separated into a number of shorter pieces or lengths for storage and the pieces then assembled end to end by connecting means before use. Preferably such connecting means comprise a screw-threaded spigot on one piece and a corresponding screw-threaded socket on the adjacent piece. To avoid difficulties in unscrewing the connection means with greasy hands, however, when there are more than three pieces or sections, gripping means such as outwardly projecting lugs are provided the or each section which is not one containing the handle or the prongs. Also to assist in propping up the fork a supporting member, axially slidable along the shaft, can be provided, the supporting member comprises a pair of domed plates placed back to back and each plate having a number of outwardly projecting arms.

U.S. Pat. No. 4,982,657, issued Jan. 8, 1991 to Ghenic, illustrates a manipulatable manual device for supporting and rotating a number of hot dogs above the surface of a grille during a cooking operation. The device is equipped with balancing elements that maintain the device in a stabilized condition on the grilled surface in spite of cantilever forces imposed by the supported hot dogs. An elongated handle is rotatably attached to a housing that mounts a number of rotary hot dog grippers. A gear mechanism within the housing transmits a drive force from the handle to the hot dog grippers.

U.S. Pat. No. 4,517,885, issued May 21, 1985 to Thompson, concerns a wiener roaster that has a shank including a first section threadably attached to a second section. A plurality of tines is integrally bound to the first section. A bearing collar rotatably slidably attaches to the first section. A first handle is bound to an end of the second section for gripping the wiener roaster. A second handle is slidably rotatably positioned about the second section in an area between the threadably securing point of the first section to the second section and the first handle. A stand is provided, which may be implanted in the ground. The stand has a structure defining a bifurcated bearing face wherein the bearing collar removably rotatably lodges as the tines impale wieners and is rotatably situated over a fire, or the like. A method for roasting wieners includes impaling at least one wiener on a tine pivotably secured at the end of a first shaft of a fold-up wiener roaster having a second shaft pivotably secured to the first shaft. The method additionally includes positioning the impaled wiener over a fire, or the like, and rotating the positioned impaled wiener over the fire to evenly roast the wiener.

U.S. Pat. No. D377,888, issued Feb. 11, 1997 to Griffin, shows the ornamental design for a hand held rotisserie for hot dogs and marshmallows.

U.S. Pat. No. 5,117,558, issued Jun. 2, 1992 to Hull, shows a hand-held rotary barbecue rotisserie that includes an elongated shaft having multiple prongs on which wieners, marshmallows, or other food is impaled for cooking. The shaft end opposite the cooking prongs is formed in to an eccentric crank handle, which is used for turning the cooking food. A heat-insulating sleeve is placed on the shaft. The sleeve would typically be held in one hand while the other hand would rotate the crank handle. The shaft can be one single piece or can be separated into smaller components for easier storage.

U.S. Pat. No. 3,966,103, issued Jun. 29, 1976 to Abrams, provides a holder for both supporting and carrying napkins and containers, such as condiment bottles. The holder includes a lower tray for napkins and an upper tray supported thereabove on struts for containers. The struts are constructed with vertically extending slots in which a retaining bar is received to rest upon the napkins and hold them securely in place. A handle extends above the upper tray to provide means for readily transporting the tray, while at the same time providing structure to engage and help support the containers. Flanges are provided around the perimeter of the upper and lower trays to assist in holding the containers and napkins in place.

U.S. Pat. No. D408,691, issued Apr. 27, 1999 to Tisdale, depicts the ornamental design for a combined napkin, salt and pepper container holder.

U.S. Pat. No. D396,171, issued Jul. 21 1998 to Conway, describes the ornamental design for a combined condiment caddy and napkin holder.

U.S. Pat. No. D144,105, issued Mar. 12, 1946 to Dye, concerns the ornamental design for a combination holder for napkins and condiment sets.

U.S. Pat. No. D324,155, issued Feb. 25, 1992 to Hyman, illustrates the ornamental design for a combined napkin holder and condiment caddy.

U.S. Pat. No. D323,956, issued Feb. 18, 1992 to Abrams, is for the ornamental design for a combined napkin holder and condiment caddy.

U.S. Pat. No. D439,804, issued Apr. 3, 2001 to Pulitano, indicates the ornamental design for a table top organizer for condiment containers, menus and napkins.

What is needed is a simple economical device for roasting hot dogs and other food items over a stovetop burner or other open fire source, and especially such a device which also holds associated items for eating, such as napkins and condiments.

### SUMMARY OF THE INVENTION

An object of the present invention is to provide a simple economical device for roasting hot dogs and other food items over a stovetop burner or other open fire source, and especially such a device which also holds associated items for eating, such as napkins and condiments so that the device is normally positioned out on a counter top or in a convenient cupboard and can be quickly accessed and instantly employed for stovetop roasting or barbequing or campfire cooking.

Another object of the present invention is to provide a turnable fork which is pivotally mounted to the top of the napkin and condiment holder, which fork shaft rests within two protruding rings on top of the napkin and condiment holder having a protruding working end with the fork over the fire and a protruding handle end for turning the fork so that the hot dog or other food item may be turned easily over the fire and may also be held still by the napkin and condiment holder as desired.

One more object of the present invention is to provide a fork which has a long shaft which is separable so that the working end fork portion is removable so that the remaining portion of the fork handle acts as a carrying handle for the napkin and condiment holder.

A related object of the present invention is to provide a fork which is easily removable from the napkin and condiment holder for cleaning the fork and for separate storage if desired by either sliding the fork and shaft out of the rings on the napkin and condiment holder or unscrewing the working end of the fork shaft to remove only the fork head and leave the rest of the fork shaft to serve as a carrying handle for the napkin and condiment holder.

An additional object of the present invention is to provide the napkin and condiment holder with an end plate at the working end of the fork to serve as a heat shield to prevent the napkins from burning.

In brief, a napkin and condiment holder has a metal plate formed into an L-shape with a bottom horizontal portion of the plate serving as the base to support napkins and condiments thereon and a vertical portion serving as a heat shield and napkin support on the working end of the device. A vertical frame member spaced apart from the heat shield by a portion of the length of the bottom plate extends vertically from the bottom plate to serve as the other half of the napkin support with the napkins positioned between the two vertical elements resting on the bottom plate. A horizontal frame member extends from the vertical frame partway up the frame on a side away from the heat shield extending out to the end of the bottom plate opposite to the heat shield, the horizontal frame member serving as a retainer for condiment containers resting on the bottom plate.

A first vertical ring is attached to a top edge of the heat shield in the center of the heat shield parallel to the heat shield and a second vertical ring is attached to a top edge of the vertical frame in the center of the vertical frame parallel to the vertical frame. The two vertical rings align to receive a long-handled fork slidably inserted between the rings with a working fork end protruding beyond the heat shield on one end and a gripping handle portion of the fork extending beyond the condiment end to enable the fork to be positioned over a source of heat with one or more hot dogs or other food on the fork with the gripping handle portion being turned to turn the food over the heat for roasting.

The fork end may screw onto the long handle so that the fork end may be removed for cleaning and separate storage and the handle left in the rings to serve as a handle for lifting the napkin and condiment holder.

An advantage of the present invention is that it provides a simple economical device for roasting hot dogs and other food items over a stovetop burner or other open fire source.

Another advantage of the present invention is that it also holds associated items for eating, such as napkins and condiments so that the device is normally positioned out on a counter top or in a convenient cupboard and can be quickly accessed and instantly employed for stovetop roasting or barbequing or campfire cooking.

An additional advantage of the present invention is that it provides a turnable fork which is pivotally mounted to the top of the napkin and condiment holder, which fork may be turned easily over the fire and may also be held still by the napkin and condiment holder as desired.

One more advantage of the present invention is to provide a cooking fork end which is removable so that the remaining portion of the fork handle acts as a carrying handle for the napkin and condiment holder.

A related advantage of the present invention is that it provides a fork which is easily removable from the napkin and condiment holder for cleaning the fork and for separate storage if desired.

Yet one more advantage of the present invention is that it provides an end plate to serve as a heat shield to prevent the napkins from burning.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the napkin and condiment holder and turning fork of the present invention with the turning fork mounted in place to receive food for roasting;

FIG. 2 is a perspective view of the napkin and condiment holder and turning fork of FIG. 1 with the turning fork unscrewed from the long handle with the handle still in place to lift the napkin and condiment holder;

FIG. 3 is a perspective view of an alternate embodiment of the napkin and condiment holder and turning fork of the present invention with the turning fork mounted in place to receive food for roasting further comprising a horizontal support rod between the heat shield and the vertical frame member at the location of the two rings;

FIG. 4 is a perspective view of the napkin and condiment holder and turning fork of FIG. 1 positioned on a counter with the turning fork extending over a burner on a stove top;

FIG. 5 is a side elevational view of the turning fork of FIG. 1;.

FIG. 6 is a top plan view of the turning fork of FIG. 1;

FIG. 7 is a top plan view of the napkin and condiment holder of FIG. 1 pictured without the turning fork;

FIG. 8 is an end elevational view of the napkin and condiment holder of FIG. 1 pictured without the turning fork looking at the condiment holder end;

FIG. 9 is a side elevational view of the napkin and condiment holder of FIG. 1 pictured without the turning fork;

FIG. 10 is an end elevational view of the napkin and condiment holder of FIG. 1 pictured without the turning fork looking at the napkin holder end.

### BEST MODE FOR CARRYING OUT THE INVENTION

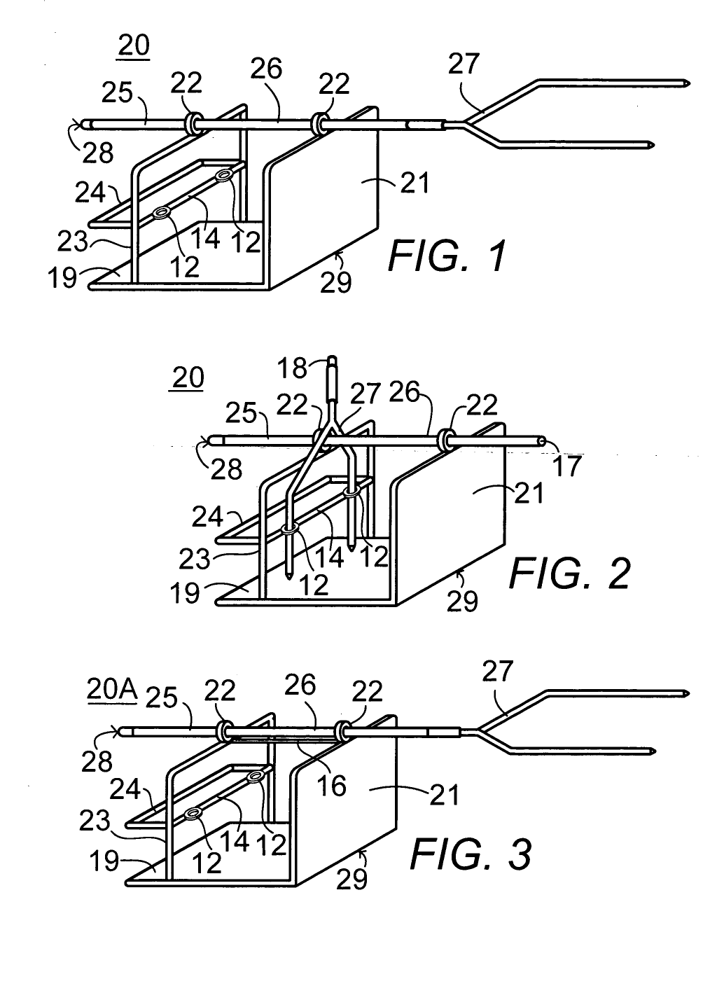

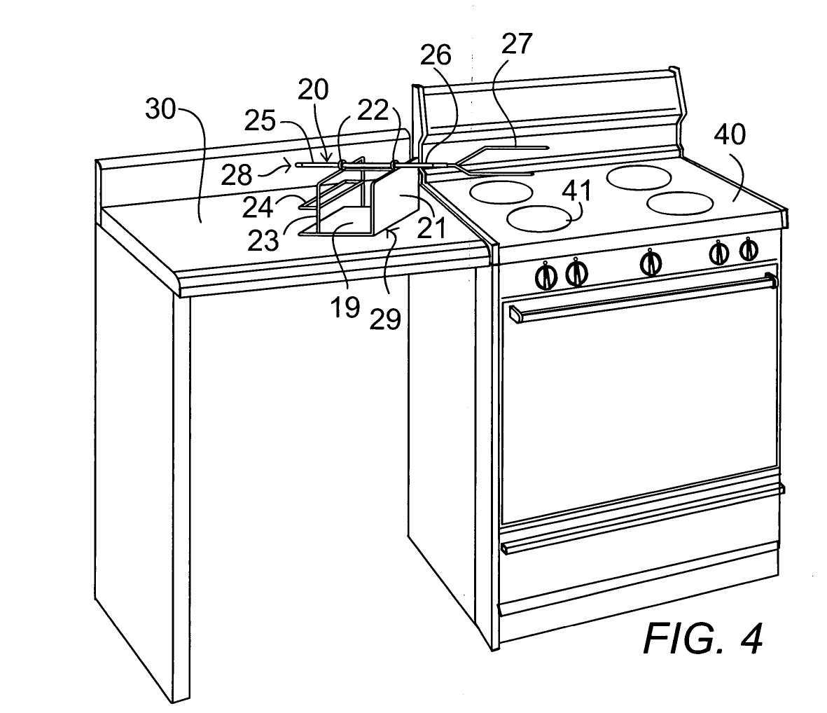

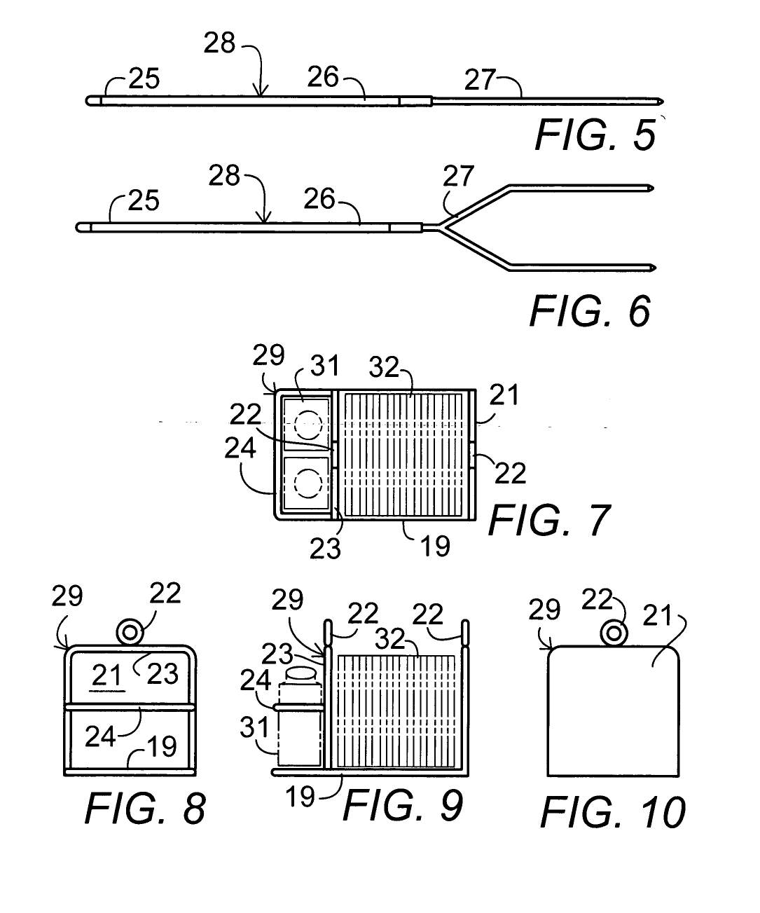

In FIGS. 1-10, a napkin and condiment holder with turnable roasting fork device 20 and 20A comprises a napkin and condiment holder 29 and a turnable long handled fork 28 adapted for positioning on a surface 30, such as a countertop, and roasting food over an adjacent heat source 41, such as a top burner on a stove top 40, as seen in FIG. 4.

In FIGS. 1-4 and 7-10, the napkin and condiment holder 29 comprises a metal plate formed into an L-shape with a bottom horizontal portion 19 of the plate adapted as a base to support napkins 32 and condiments 31 thereon, as seen in FIGS. 7 and 9, and a vertical portion 21 serving as a heat shield and a first napkin support on a working end of the device. A vertical frame member 23, which may be heavy gage wire, tubing or other rigid preferably metal material bent into an inverted square U shape, is spaced apart from the heat shield by a portion of the length of the bottom plate and is preferably welded to the bottom plate. The vertical frame member 23 extends vertically from the bottom plate 19 to serve as a second napkin support with napkins 32 resting on the bottom plate 19 between the heat shield 21 and the vertical frame member 23. A horizontal frame member 24, preferably heavy gage wire, tubing or other rigid preferably metal material bent into a horizontal square U shape, is attached by the ends of the legs of the U to the vertical frame member 23 partway up the vertical frame member on a side away from the heat shield, and extends out to a end of the bottom plate opposite to the heat shield. The horizontal frame member 24 is adapted to serve as a retainer for condiment containers 31, as seen in FIGS. 7 and 9 resting on the bottom plate with the condiment containers held in the horizontal U shape. A cross bar 14 attached, preferably by welding, between the sides of the vertical frame member 23 further serves to retain the condiment containers. Two horizontal rings 12 attached, preferably by welding, to the cross bar 14 serve to hold the detachable fork 27 inserted through the rings with the points of the fork resting on the bottom plate 19 when the fork is not in use, as seen in FIG. 2.

The napkin and condiment holder 29 further comprises a first vertical ring 22 attached to a top edge of the heat shield 21 in the center of the heat shield parallel to the heat shield and a second vertical ring 22 attached to a top edge of the vertical frame 23 in the center of the vertical frame parallel to the vertical frame with the two vertical rings aligned.

In FIGS. 1-6, the device 20 further comprises a long-handled fork 28 slidably insertable between the rings 22, as seen in FIGS. 1-4. The long-handled fork 28 comprising a working fork end 27 having at least two fork thongs protruding therefrom, the working fork end adapted for receiving and retaining at least one food item thereon, such as a hot dog or other food item for roasting. The working fork end 27 protrudes beyond the heat shield 21 on the working end of the device and the long-handled fork further comprising a gripping handle portion 25 attached to the long handled fork 28 at an end opposite to the working fork end the gripping handle portion adapted for holding and turning the long handled fork. The gripping handle portion 25 extends beyond an end of the device opposite to the working end of the device.

In FIG. 4, the device 20 is adapted for resting on a surface 30, such as a counter top, adjacent to an external heat source 41, such as a top burner on a stove top 40, and positioning the working fork end 27 over an external source of heat with at least one food item on the working fork end 27 with the gripping handle portion 25 adapted for being turned to turn the at least one food item over the external heat source for roasting. The heat shield 21 prevents the napkins 32 from catching fire.

In FIG. 2, the long handled fork 28 preferably comprises at least two separable pieces, a handle portion 26 and a separable working fork end 27 adapted to be separably attachable to the handle portion 26, preferably by a threaded protrusion 18 from one fitting into a threaded opening 17 in the other, so that the working fork end 27 may be removed for cleaning and separate storage and the handle portion 26 may remain positioned in the rings to serve as a handle for lifting the napkin and condiment holder 29.

In FIG. 3, an alternate embodiment of the device 20A further comprises a horizontal support rod 16 between the heat shield 21 and the vertical frame member 23 at the location of the two rings 22 to assist in maintaining the rigid structure of the device and also serve as a handle.

It is understood that the preceding description is given merely by way of illustration and not in limitation of the invention and that various modifications may be made thereto without departing from the spirit of the invention as claimed.

1. A napkin and condiment holder with turnable roasting fork device comprising:
a napkin and condiment holder comprising a metal plate formed into an L-shape with a bottom horizontal portion of the plate adapted as a base to support napkins and condiments thereon and a vertical portion serving as a heat shield and a first napkin support on a working end of the device, a vertical frame member spaced apart from the heat shield by a portion of the length of the bottom plate, the vertical frame member extending vertically from the bottom plate to serve as a second napkin support with napkins resting on the bottom plate between the heat shield and the vertical frame member, a horizontal frame member attached to and extending from the vertical frame member partway up the vertical frame member on a side away from the heat shield, the horizontal frame member extending out to a end of the bottom plate opposite to the heat shield, the horizontal frame member adapted to serve as a retainer for condiment containers resting on the bottom plate, a first vertical ring attached to a top edge of the heat shield in the center of the heat shield parallel to the heat shield and a second vertical ring attached to a top edge of the vertical frame in the center of the vertical frame parallel to the vertical frame with the two vertical rings aligned;
a long-handled fork slidably insertable between the rings, the long-handled fork comprising a working fork end having at least two fork thongs protruding therefrom, the working fork end adapted for receiving and retaining at least one food item thereon, the working fork end protruding beyond the heat shield on the working end of the device and the long-handled fork further comprising a gripping handle portion attached to the long handled fork at an end opposite to the working fork end, the gripping handle portion adapted for holding and turning the long handled fork, the gripping handle portion adapted for extending beyond an end of the device opposite to the working end of the device, the device adapted for resting on a surface adjacent to an external heat source and positioning the working fork end over an external source of heat with at least one food item on the working fork end with the gripping handle portion adapted for being turned to turn the at least one food item over the external heat source for roasting.

2. The device of claim 1 wherein the long handled fork comprises at least two separable pieces, a handle portion and a separable working fork end adapted to be separably attachable to the handle portion so that the working fork end is adapted for removing for cleaning and separate storage and the handle portion is adapted for being positioned in the rings to serve as a handle for lifting the napkin and condiment holder.

3. The device of claim 2 wherein the working fork end comprises two spaced apart prongs and the device further comprises a horizontal cross bar attached to the vertical frame member and two horizontal rings attached to the cross bar in a spaced apart a sufficient distance to receive the prongs inserted therein with the ends of the prongs resting on the bottom plate when the fork is not in use.

4. The device of claim 1 further comprising a horizontal support rod between the heat shield and the vertical frame member at the location of the two rings to assist in maintaining the ridge structure of the device and also serve as a handle.
